(19) United States
(12) Patent Application Publication
(10) Pub. No.: US 2014/0010348 A1
(43) Pub. Date: Jan. 9, 2014

(54) RADIATION GENERATING APPARATUS AND RADIATION IMAGE TAKING SYSTEM

(71) Applicant: CANON KABUSHIKI KAISHA, Tokyo (JP)

(72) Inventor: Kazuya Tsujino, Tokyo (JP)

(21) Appl. No.: 13/927,805

(22) Filed: Jun. 26, 2013

(30) Foreign Application Priority Data
Jul. 3, 2012 (JP) 2012-149085

(51) Int. Cl. G21K 1/00; G21K 1/10

(52) U.S. Cl. CPC G21K 1/00; G21K 1/10
USPC 378/62; 378/161; 378/145; 378/159

(57) ABSTRACT

Provided is a radiation generating apparatus, including a radiation generating unit for emitting radiation through a transmission window, and a light projecting/sighting device including a light source for emitting visible light and a reflection mirror. At least one of the transmission window and the reflection mirror has variations in thickness for reducing shading of radiation which irradiates a radiation irradiation field.

### BACKGROUND OF THE INVENTION

1. Field of the Invention

The present invention relates to a radiation generating apparatus including a light projecting and sighting device (hereinafter, referred to as “light projecting/sighting device”) and a radiation image taking system using the radiation generating apparatus.

2. Description of the Related Art

A radiation generating apparatus includes a light projecting/sighting device for irradiating, with visible light, a region coincident with a radiation irradiation field so that the radiation irradiation field can be visually recognized. The light projecting/sighting device irradiates a subject with visible light emitted from a visible light source and reflected by a reflection mirror. Generally, the reflection mirror is provided so as to cover the irradiation path of radiation, and reflects visible light and transmits radiation.

It is known to, by causing the reflection mirror to be movable and retracting the reflection mirror when radiation is emitted, prevent reduction in radiation quantity due to passing of the radiation through the reflection mirror (see, for example, Japanese Patent Application Laid-Open No. 2005-006971).

A typical radiation generating apparatus is described with reference to FIG. 6. A housing 101 includes a radiation tube 103 having a focal point 102 as a source of radiation, and a transmission window 104 which limits the region irradiated with radiation emitted from the focal point 102.

A reflection mirror 105 formed of a glass plate or the like includes on one surface thereof a reflection plane 106 for reflecting visible light. The reflection mirror 105 reflects visible light and transmits radiation. The reflection mirror 105 is provided so as to cover the entire region irradiated with radiation which is emitted through the transmission window 104 and so that the reflection plane 106 thereof forms an angle of about 45 degrees with a central axis 107 of the radiation. A light source unit 108 is provided so as to limit the region which is irradiated with visible light emitted from a light source 109 and so that the region which corresponds to the radiation irradiation field is irradiated with visible light reflected by the reflection plane 106. This enables visual recognition of the radiation irradiation field before the radiation is emitted.

However, the reflection mirror 105 is provided so as to be slanted with respect to the central axis 107, and thus, depending on the irradiation direction of the radiation, the angle at which the radiation passes through the reflection mirror 105 differs. This difference in transmission angle varies the radiation quality and the radiation quantity of the transmitted radiation, which is referred to as the filtering effect of the reflection mirror 105.

By the way, when the radiation tube 103 is a reflection type radiation tube, it is known that, due to the heel effect, the radiation quality and the radiation quantity of radiation varies depending on the irradiation direction of the radiation. By appropriately selecting the direction of slant of the reflection mirror 105, the filtering effect of the reflection mirror 105 and the heel effect of the reflection type radiation tube can be canceled out.

However, when the radiation tube 103 is a transmission type radiation tube, substantially no heel effect is caused, and thus, only the filtering effect of the reflection mirror 105 acts, which causes nonuniformity in radiation quality and radiation quantity in relation to the location of the radiation irradiation field (hereinafter referred to as shading). The shading is described in detail with reference to FIG. 5A.

The reflection mirror 105 is a plate having a uniform thickness t, and is provided so as to be slanted by an angle φ with respect to the central axis 107. In this case, radiation which is emitted from the focal point 102 and travels along the central axis 107 passes through the reflection mirror 105 at a transmission length of t/sin φ. On the other hand, the transmission lengths of radiations 107a and 107b which are emitted from the focal point 102 and travel so as to form an angle θ with respect to the central axis 107 pass through the reflection mirror 105 at varying transmission lengths depending on the positional relationship with the reflection mirror 105.

The transmission length of the radiation 107a which passes through a portion of the reflection mirror 105 that is close to the focal point 102 is t/sin(φ+θ), while the transmission length of the radiation 107b which passes through a portion of the reflection mirror 105 that is distant from the focal point 102 is t/sin(φ−θ). In this way, with regard to the filtering effect of the reflection mirror 105, the normal to the reflection mirror 105 is slanted with respect to the central axis 107, and thus, the transmission length of the radiation which passes through the reflection mirror 105 varies depending on the irradiation direction of the radiation.

Further, even when the radiation tube 103 is a reflection type radiation tube, depending on the angle at which the reflection mirror 105 is provided, the heel effect may not effectively reduce the shading.

By causing the reflection mirror 105 to be movable and retracting the reflection mirror 105 when radiation is emitted, the above-mentioned problem is prevented, but a mirror retracting mechanism is required to be additionally provided, and thus, not only the structure is complicated but also the size of the apparatus is increased.

### SUMMARY OF THE INVENTION

Accordingly, it is an object of the present invention to reduce shading in a light projecting/sighting device of a radiation generating apparatus without increasing the size of the apparatus.

In order to solve the above-mentioned problem, according to an aspect of the present invention, there is provided a radiation generating apparatus, including:

a radiation generating unit for emitting radiation through a transmission window; and

a light projecting/sighting device including:
a light source for emitting visible light; and
a reflection mirror provided so as to be slanted with respect to a radiation central axis and having a reflection plane for reflecting the visible light, the reflection mirror being configured to transmit the radiation,
the light projecting/sighting device being configured to make a simulation display of a radiation irradiation field formed of the radiation emitted from the radiation generating unit and passing through the reflection mirror, using a light irradiation field formed of the visible light reflected by the reflection mirror,

in which at least one of the transmission window and the reflection mirror has variation in thickness for reducing shading of the radiation that irradiates the radiation irradiation field.

Further, according to another aspect of the present invention, there is provided a radiation generating apparatus, including:

a radiation generating unit for emitting radiation through a transmission window; and

a light projecting/sighting device including:
a light source for emitting visible light;
a reflection mirror provided so as to be slanted with respect to a radiation central axis, for reflecting the visible light, the reflection mirror being configured to transmit the radiation,
the light projecting/sighting device being configured to make a simulation display of a radiation irradiation field formed of the radiation emitted from the radiation generating unit and passing through the reflection mirror, using a light irradiation field formed of the visible light reflected by the reflection mirror; and

a filter plate for removing unnecessary radiation,

in which the filter plate has variation in thickness for reducing shading of the radiation that irradiates the radiation irradiation field.

Further features of the present invention will become apparent from the following description of exemplary embodiments with reference to the attached drawings.

### BRIEF DESCRIPTION OF THE DRAWINGS

FIG. 1 illustrates a radiation generating apparatus according to a first embodiment of the present invention.

FIG. 2 illustrates a radiation generating apparatus according to a second embodiment of the present invention.

FIG. 3 illustrates a radiation generating apparatus according to a third embodiment of the present invention.

FIG. 4 illustrates a radiation generating apparatus according to a fourth embodiment of the present invention.

FIGS. 5A and 5B are explanatory diagrams for illustrating transmission paths in mirror plates for radiation.

FIG. 6 illustrates a conventional radiation generating apparatus.

FIG. 7 illustrates a radiation image taking system according to the present invention.

### DESCRIPTION OF THE EMBODIMENTS

Embodiments of the present invention are described in the following with reference to the attached drawings. Throughout the figures referred to in the following, like reference symbols are used to designate like components. Radiation used in the embodiments is an X-ray, but the present invention is also applicable to a γ-ray and neutron radiation.

[Radiation Generating Apparatus According to First Embodiment]

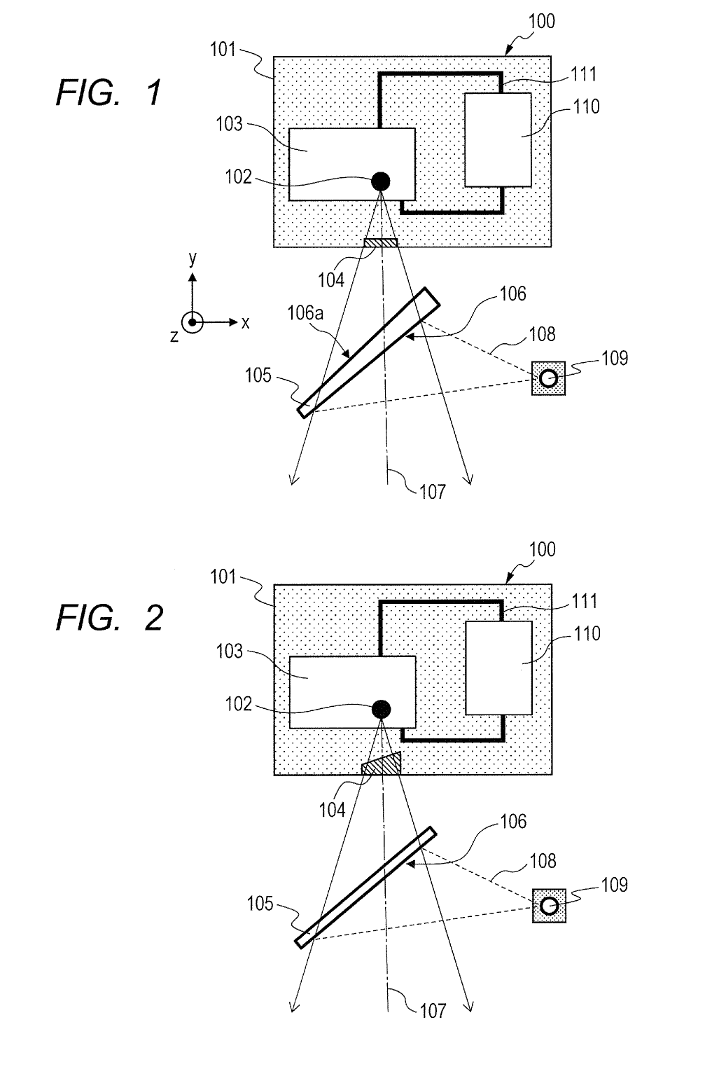

FIG. 1 is a schematic view illustrating a radiation generating apparatus according to a first embodiment of the present invention.

A radiation generating unit 100 includes a housing 101, and a transmission type radiation tube (hereinafter referred to as radiation tube) 103 and a radiation tube drive circuit (hereinafter referred to as drive circuit) 110 for driving the radiation tube 103 both provided therein. Further, the space remaining in the housing 101 is filled with an insulating liquid 111 as a cooling medium.

The radiation tube 103 generates radiation by accelerating electrons generated from an electron source and colliding the electrons against a target.

A focal point 102 is the center of a radiation generating region, and corresponds to the center of a region of the target irradiated with an electron beam. Further, the housing 101 includes a radiation transmission window (hereinafter referred to as transmission window) 104 that transmits radiation emitted from the focal point 102 located in the radiation tube 103 while limiting the irradiation field of the radiation.

A reflection mirror 105 includes on one surface thereof a reflection plane 106 for reflecting visible light. The reflection mirror 105 can transmit radiation. The reflection mirror 105 is provided so as to cover the entire region irradiated with radiation limited by the transmission window 104 and so that the normal to the reflection plane 106 and a radiation central axis (hereinafter referred to as central axis) 107 form a predetermined angle. The reflection mirror 105 is slanted with respect to the central axis 107, and thus, a right side of the reflection mirror 105 is close to the focal point 102 and a left side of the reflection mirror 105 is distant from the focal point 102. The central axis 107 as used herein is a straight line which connects the center of the transmission window 104 and the focal point 102, and the center of the transmission window 104 as used herein is a location corresponding to, when a plate material having the same shape and size as those of the transmission window 104 and having a uniform thickness is assumed, the center of gravity of the plate material.

The reflection mirror 105 has variation in thickness for reducing shading of radiation which irradiates the radiation irradiation field. The reflection mirror 105 is formed of a plate having variation in thickness so as to have the shape of a wedge in section. The thickness gradually changes so that the side which is close to the focal point 102 is thick and the side which is distant from the focal point 102 is thin. Shading of radiation as used herein means that at least any one of the radiation quantity and the radiation quality of radiation which passes through the reflection mirror 105 is nonuniform. In particular, it is important to reduce difference in radiation quantity in the radiation irradiation field.

A light source unit 108 limits the region irradiated with visible light emitted from a light source 109, and is provided so that the region irradiated with light which is emitted from the light source 109 via the reflection plane 106 corresponds to the irradiation field of radiation emitted through the transmission window 104. Formation of a light irradiation field which is coincident with the radiation irradiation field enables simulation display of the radiation irradiation field with visible light, and the radiation irradiation field can be visually recognized in advance.

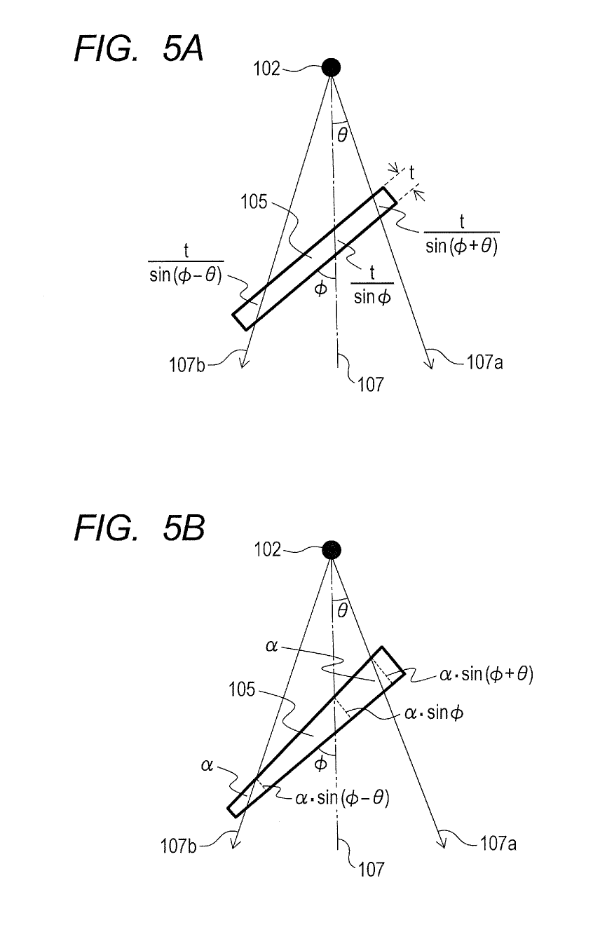

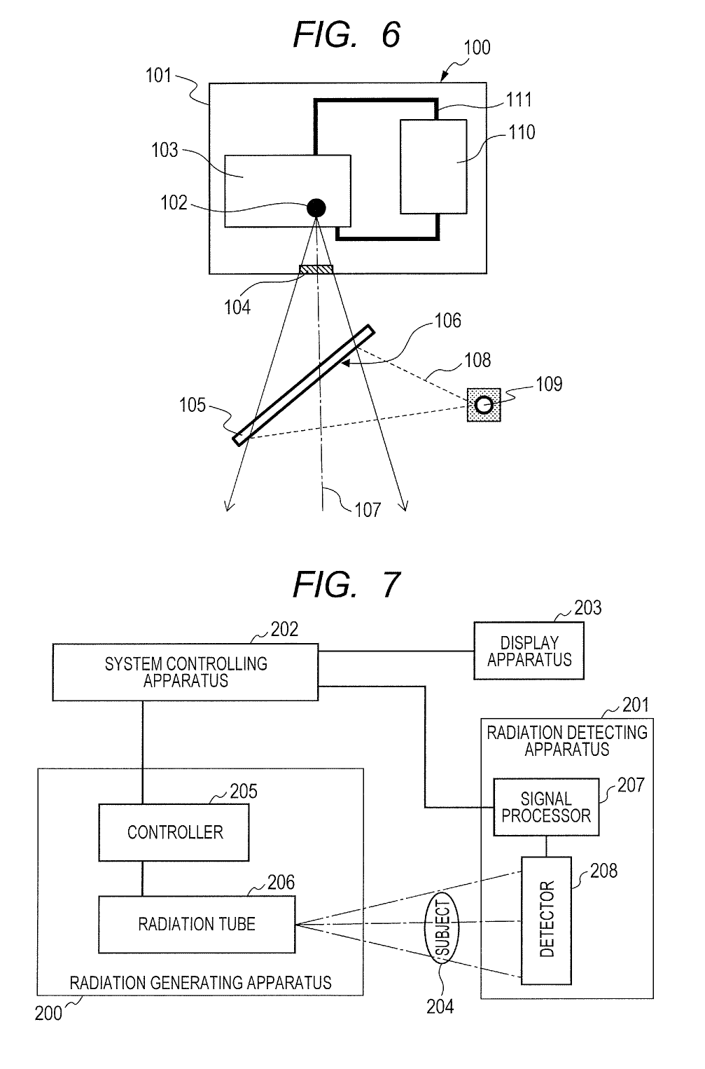

FIG. 5B is an explanatory diagram for illustrating a state in which radiation passes through the reflection mirror. The reflection mirror 105 is a plate having variation in thickness so as to have the shape of a wedge in section. The reflection mirror 105 is provided so that the normal to the reflection plane 106 is slanted by an angle φ with respect to the central axis 107. When the transmission length of radiation which passes through the reflection mirror 105 is required to be set to be “a”, the thickness of the portion of the plate through which the radiation emitted from the focal point 102 passes along the central axis 107 is set to a·sin φ. Further, with regard to radiations 107a and 107b which form an angle θ with respect to the central axis 107, the thickness of the portion of the plate through which the radiation 107a passes is set to a·sin(φ+θ) and the thickness of the portion of the plate through which the radiation 107b passes is set to a·sin(φ−θ). In this manner, it is possible to eliminate the difference in transmission length depending on the irradiation direction. Shading due to the difference in transmission length is reduced.

This shading is caused not only in an X-Y plane (within the plane of the drawing sheet) but also in a Y-Z plane (plane perpendicular to the plane of the drawing sheet, in a Z direction). However, the reflection mirror 105 is not slanted in the Y-Z plane, and thus, the effect of the shading in the Y-Z plane is smaller than that in the X-Y plane. A surface opposite to the reflection plane 106 can be bulged so that the reflection mirror 105 becomes gradually thinner from the center to the periphery in the Y-Z plane under a state in which the flatness of the reflection plane of the reflection mirror 105 is maintained. By causing the reflection mirror 105 to also have such variation in thickness, the shading in the Y-Z plane can be reduced. In that case, the reflection mirror 105 can have a shape in which, in the Z direction, ends thereof have thicknesses corresponding to a·sin(φ+θ) and a·sin(φ−θ), respectively, with the center thereof having a thickness corresponding to a·sin φ. In this manner, uniform radiation is emitted also in the Y-Z plane.

The reflection mirror 105 can be formed of a single plate material, but can also be formed of a base material layer such as an acrylic board with a reflective material layer forming the reflection plane 106 added thereto. It is preferred that the base material layer be a material which easily transmits radiation and on which the reflection plane 106 can be provided. Further, the reflection plane 106 is obtained by forming a thin film having excellent reflection property of visible light on the base material layer. As the material of the thin film, aluminum or silver is used.

When the reflection mirror 105 is formed of a single plate material, the variation in thickness of the reflection mirror 105 is realized as variation in thickness of the plate material. When the reflection mirror 105 is formed of a stack of a base material layer and a reflective material layer, the variation in thickness of the reflection mirror 105 may be realized as variation in thickness of the base material layer, or as variation in thickness of the reflective material layer, or further, as variations in thickness of both the base material layer and the reflective material layer. In any of these cases, the amount of the variation in thickness can be determined from the transmittances of radiation through the materials which form the base material layer and the reflective material layer, respectively.

As the light source 109, an incandescent lamp, a halogen lamp, a xenon lamp, or an LED is used.

[Radiation Generating Apparatus According to Second Embodiment]

FIG. 2 is a schematic view illustrating a radiation generating apparatus according to a second embodiment of the present invention.

In this embodiment, the reflection mirror 105 is a plate having a uniform thickness, and the transmission window 104 has variation in thickness for reducing shading of radiation which irradiates the radiation irradiation field. Specifically, the transmission window 104 has variation in thickness so as to have the shape of a wedge in section and so that the side thereof on which the focal point 102 and the reflection mirror 105 are close to each other is thick and the side thereof on which the focal point 102 and the reflection mirror 105 are distant from each other is thin.

By forming the transmission window 104 into the shape as described above, radiation which passes through the transmission window 104 and the ordinary reflection mirror 105 having a uniform thickness can be uniform radiation. Then, radiation with reduced shading can irradiate the radiation irradiation field.

As described in the first embodiment, by bulging at least one surface of the transmission window 104 so that the transmission window 104 becomes gradually thinner from the center to the periphery in order to reduce the shading in the Z direction, the transmission window 104 can also have such variation in thickness. Further, only any one of the reflection mirror 105 and the transmission window 104 may have variation in thickness, but both of the two may have variations in thickness and the variations in thickness of the two may reduce the shading.

[Radiation Generating Apparatus According to Third Embodiment]

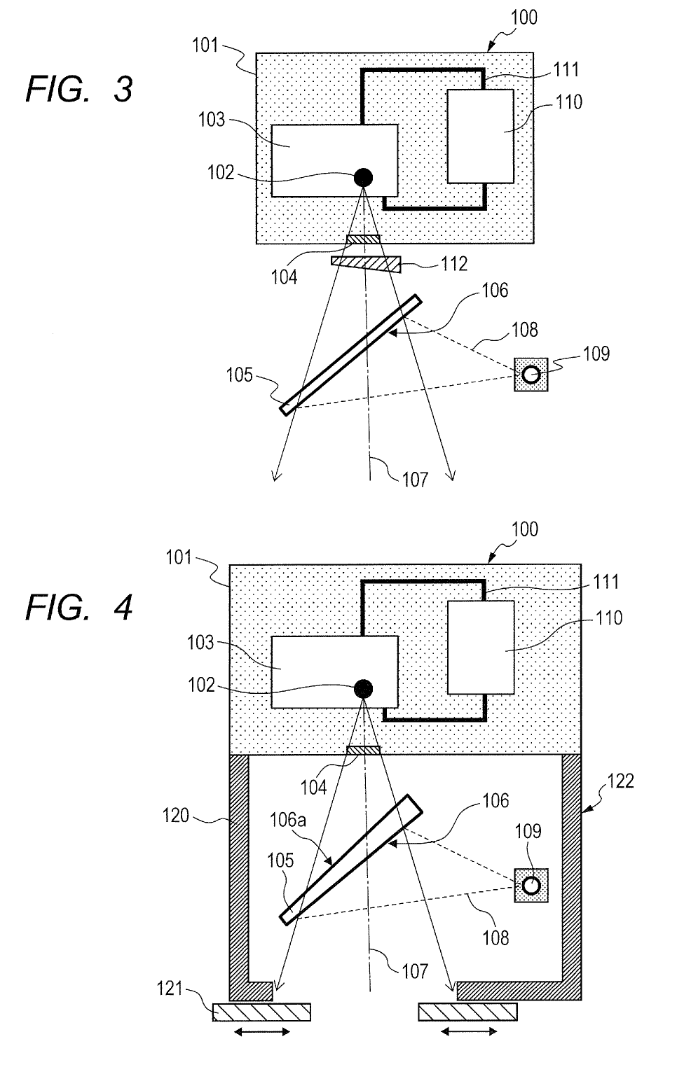

FIG. 3 is a schematic view illustrating a radiation generating apparatus according to a third embodiment of the present invention.

In this embodiment, a filter plate 112 is provided between the transmission window 104 and the reflection mirror 105. The filter plate 112 has variation in thickness for reducing shading of radiation which passes through the reflection mirror 105. The filter plate 112 has the shape of a wedge in section so that the side thereof on which the radiation source and the reflection mirror are close to each other is thick and the side thereof on which the radiation source and the reflection mirror are distant from each other is thin. Radiation which passes through the reflection mirror 105 is uniform and the shading is reduced.

As described in the first embodiment, by bulging at least one surface of the filter plate 112 so that the filter plate 112 becomes gradually thinner from the center to the periphery in order to reduce the shading in the Z direction, the filter plate 112 can also have such variation in thickness.

Further, the filter plate 112 can have the function of reducing unnecessary radiation. Exemplary unnecessary radiation includes a soft X-ray having energy of about 10 keV or less. A soft X-ray has a low penetrating power, and thus, is unnecessary for taking an image, for fluoroscopy, or the like, but is liable to be absorbed by a subject. Therefore, except for a case in which a soft X-ray is used, the filter plate 112 can be provided as means for blocking a soft X-ray.

[Radiation Generating Apparatus According to Fourth Embodiment]

FIG. 4 is a schematic view illustrating a radiation generating apparatus according to a fourth embodiment of the present invention. In this embodiment, an envelope 120 is provided so as to surround the reflection mirror 105 and the light source unit 108. The envelope 120 is a radiation shield and is coupled to the housing 101. The envelope 120 has an opening provided therein on a side opposite to the housing 101. A Movable adjusting blade 121 for adjusting the size of the radiation irradiation field is provided outside the opening in the envelope 120. The envelope 120 and the adjusting blade 121 form, together with the light projecting/sighting device including the reflection mirror 105 and the light source unit 108, a movable diaphragm unit 122. The adjusting blade 121 is provided outside the opening, but can also be provided in the envelope 120 between the opening and the reflection mirror 105.

The movable diaphragm unit enables not only adjustment of the size of the radiation irradiation field but also formation of a light irradiation field corresponding thereto.

[Radiation Image Taking System According to Embodiment]

FIG. 7 is a block diagram of a radiation image taking system according to the present invention. A system controlling apparatus 202 controls a radiation generating apparatus 200 which is similar to the radiation generating apparatus described in the first to third embodiments and a radiation detecting apparatus 201 in a coordinated manner. A controller 205 outputs various kinds of control signals to a radiation tube 206 under the control of the system controlling apparatus 202. A control signal controls the emission state of radiation emitted from the radiation generating apparatus 200. Radiation emitted from the radiation generating apparatus 200 passes through a subject 204 and is detected by a detector 208. The detector 208 converts detected radiation into an image signal and outputs the image signal to a signal processor 207. The signal processor 207 performs predetermined signal processing of the image signal under the control of the system controlling apparatus 202, and outputs the processed image signal to the system controlling apparatus 202. Based on the processed image signal, the system controlling apparatus 202 outputs, to a display apparatus 203, a display signal for causing the display apparatus 203 to display an image. The display apparatus 203 displays on a screen an image based on the display signal as an image of the subject 204.

The radiation generating apparatus and the radiation image taking system according to the present invention can be used as an X-ray generating apparatus and an X-ray image taking system. The X-ray image taking system can be used for non-destructive testing of an industrial product or pathological diagnosis of a human or an animal.

### EXAMPLES

### Example 1

The radiation generating apparatus configured as illustrated in FIGS. 1 and 5B was manufactured.

The size of the transmission window 104 was set so that radiation emitted from the focal point 102 had a spread of θ=15° at the maximum with respect to the central axis 107. The reflection mirror 105 included a base material layer which was an acrylic board and a reflective material layer which was a film formed by vapor depositing aluminum, and was provided so that the normal to the reflection plane 106 and the central axis 107 formed an angle φ of 45°. Further, the base material layer had variation in thickness so that the transmission length “a” of radiation which passed through the reflection mirror 105 was about 3 mm.

In this example, the thickness of the portion of the base material layer through which radiation emitted along the central axis 107 passed was 2.05 mm. Further, the thickness of the portion of the base material layer on the side which was close to the focal point 102 through which radiation emitted so as to form the angle θ=15° passed was 2.6 mm, and the thickness of the portion of the base material layer on the side which was distant from the focal point 102 through which radiation emitted so as to form the angle θ=15° passed was 1.5 mm. As the reflection plane 106, a film formed by vapor depositing aluminum at a thickness of 10 μm was provided. Further, the light source unit 108 was provided with the location thereof being adjusted so that the region irradiated with visible light emitted from the light source 109 via the reflection plane 106 corresponded to the irradiation field of radiation emitted through the transmission window 104. Further, at this time, the size and the location of the light source unit 108 were adjusted so that the light source unit 108 did not interfere with necessary radiation which irradiated the radiation irradiation field. In this manner, it was possible to reduce the difference in transmission length of the reflection mirror 105 depending on the irradiation direction of the radiation to reduce shading.

### Example 2

The radiation generating apparatus configured as illustrated in FIG. 2 was manufactured.

The reflection mirror 105 included a base material layer which was an acrylic board having a uniform thickness and a reflective material layer which was formed by vapor depositing aluminum. Further, the transmission window 104 was provided in the shape of a wedge in section so that the side thereof on which the focal point 102 and the reflection mirror 105 were close to each other was at a thickness of 4 mm and the side thereof on which the focal point 102 and the reflection mirror 105 were distant from each other was at a thickness of 3 mm. Portions other than that were similar to those in Example 1. It was possible to obtain an effect equivalent to that in Example 1 using the standard reflection mirror 105.

### Example 3

The radiation generating apparatus configured as illustrated in FIG. 3 was manufactured.

The reflection mirror 105 included a base material layer which was an acrylic board having a uniform thickness and a reflective material layer which was formed by vapor depositing aluminum. Further, the filter plate 112 made of aluminum in the shape of a wedge in section was provided in an intermediate portion between the reflection mirror 105 and the transmission window 104 so that the side thereof on which the focal point 102 and the reflection mirror 105 were close to each other was at a thickness of 2 mm and the side thereof on which the focal point 102 and the reflection mirror 105 were distant from each other was at a thickness of 1 mm. Portions other than that were similar to those in Example 1.

It was possible to obtain an effect equivalent to that in Example 1, and in addition, it was possible to block unnecessary radiation by the filter plate 112.

In the radiation generating apparatus according to the present invention, shading due to the slantingly provided reflection mirror can be reduced by variation in thickness of any one of the reflection mirror, the transmission window, and the filter plate. Further, the present invention almost does not affect the structure and the size of the apparatus, and thus, is applicable to an existing apparatus with ease without increasing the size of the apparatus. Further, the radiation image taking system using the radiation generating apparatus according to the present invention can take a more satisfactory image with less effect of shading.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-149085, filed Jul. 3, 2012, which is hereby incorporated by reference herein in its entirety.

What is claimed is:

1. A radiation generating apparatus, comprising:
a radiation generating unit for emitting radiation through a transmission window; and
a light projecting/sighting device comprising:
a light source for emitting visible light; and
a reflection mirror provided so as to be slanted with respect to a radiation central axis and having a reflection plane for reflecting the visible light, the reflection mirror being configured to transmit the radiation,
the light projecting/sighting device being configured to make a simulation display of a radiation irradiation field formed of the radiation emitted from the radiation generating unit and passing through the reflection mirror, using a light irradiation field formed of the visible light reflected by the reflection mirror,
wherein at least one of the transmission window and the reflection mirror has variation in thickness for reducing difference in radiation quantity of the radiation that irradiates the radiation irradiation field.

2. A radiation generating apparatus, comprising:
a radiation generating unit for emitting radiation; and
a light projecting/sighting device comprising:
a light source for emitting visible light; and
a reflection mirror provided so as to be slanted with respect to a radiation central axis and having a reflection plane for reflecting the visible light, the reflection mirror being configured to transmit the radiation,
the light projecting/sighting device being configured to make a simulation display of a radiation irradiation field formed of the radiation emitted from the radiation generating unit and passing through the reflection mirror, using a light irradiation field formed of the visible light reflected by the reflection mirror,
wherein the reflection mirror has variation in thickness so that a side of the reflection mirror which is close to a focal point of the radiation is thick and a side of the reflection mirror which is distant from the focal point of the radiation is thin.

3. The radiation generating apparatus according to claim 1, wherein the radiation generating unit comprises a transmission type radiation tube.

4. The radiation generating apparatus according to claim 1, wherein the variation in thickness of the at least one of the transmission window and the reflection mirror comprises variation in thickness for reducing difference in radiation quality in the radiation irradiation field of the radiation that irradiates the radiation irradiation field.

5. The radiation generating apparatus according to claim 2, wherein:
the reflection mirror comprises a base material layer and a reflective material layer for forming the reflection plane; and
the variation in thickness of the reflection mirror comprises variation in thickness of the base material layer.

6. The radiation generating apparatus according to claim 2, wherein:
the reflection mirror comprises a base material layer and a reflective material layer for forming the reflection plane; and
the variation in thickness of the reflection mirror comprises variation in thickness of the reflective material layer.

7. The radiation generating apparatus according to claim 2, wherein the variation in thickness of the reflection mirror comprises variation in thickness formed by bulging a surface of the reflection mirror on an opposite side to the reflection plane so that the reflection mirror becomes gradually thinner from a center of the reflection mirror to a periphery thereof.

8. The radiation generating apparatus according to claim 1, wherein the variation in thickness of the transmission window comprises variation in thickness so that a side of the transmission window on which a focal point of the radiation and the reflection mirror are close to each other is thick and a side of the transmission window on which the focal point and the reflection mirror are distant from each other is thin.

9. The radiation generating apparatus according to claim 1, wherein the variation in thickness of the transmission window comprises variation in thickness formed by bulging at least one surface of the transmission window so that the transmission window becomes gradually thinner from a center of the transmission window to a periphery thereof.

10. The radiation generating apparatus according to claim 1, further comprising a filter plate for reducing unnecessary radiation,
wherein the filter plate has, together with the at least one of the transmission window and the reflection mirror, variation in thickness for reducing shading of the radiation that irradiates the radiation irradiation field.

11. The radiation generating apparatus according to claim 10, wherein the variation in thickness of the filter plate comprises variation in thickness so that a side of the filter plate on which a focal point of the radiation and the reflection mirror are close to each other is thick and a side of the filter plate on which the focal point and the reflection mirror are distant from each other is thin.

12. The radiation generating apparatus according to claim 11, wherein the variation in thickness of the filter plate comprises variation in thickness formed by bulging at least one surface of the filter plate so that the filter plate becomes gradually thinner from a center of the filter plate to a periphery thereof.

13. The radiation generating apparatus according to claim 2, further comprising a movable diaphragm device comprising:
the light projecting/sighting device; and
an adjusting blade for adjusting a size of the radiation irradiation field.

14. A radiation image taking system, comprising:
a radiation generating apparatus comprising:
a radiation generating unit for emitting radiation through a transmission window; and
a light projecting/sighting device comprising:
a light source for emitting visible light; and
a reflection mirror provided so as to be slanted with respect to a radiation central axis and having a reflection plane for reflecting the visible light, the reflection mirror being configured to transmit the radiation,
the light projecting/sighting device being configured to make a simulation display of a radiation irradiation field formed of the radiation emitted from the radiation generating unit and passing through the reflection mirror, using a light irradiation field formed of the visible light reflected by the reflection mirror,
at least one of the transmission window and the reflection mirror having variation in thickness for reducing shading of the radiation that irradiates the radiation irradiation field;
a radiation detecting apparatus for detecting the radiation that is emitted from the radiation generating apparatus and passes through a subject; and
a controlling apparatus for controlling the radiation generating apparatus and the radiation detecting apparatus in a coordinated manner.
